(19) United States
(12) Patent Application Publication
(10) Pub. No.: US 2023/0022370 A1
(43) Pub. Date: Jan. 26, 2023

(54) ARCHITECTURAL PANEL AND METHOD FOR MANUFACTURING THE SAME

(71) Applicant: Arktura LLC, Gardena, CA (US)

(72) Inventors: Chris Kabatsi, Venice, CA (US); Robert Kilian, Venice, CA (US); Kevin Kane, Los Angeles, CA (US); Moti Tavassoli, Culver City, CA (US); John Johnston, North Hollywood, CA (US)

(21) Appl. No.: 17/864,142

(22) Filed: Jul. 13, 2022

Related U.S. Application Data
(60) Provisional application No. 63/223,737, filed on Jul. 20, 2021.

(51) Int. Cl. B21D 28/26; B21D 5/16; B21D 28/24

(52) U.S. Cl. CPC B21D 28/265; B21D 5/16; B21D 28/246; E04B 1/86

(57) ABSTRACT

A method for manufacturing an architectural panel and an architectural panel made by the method. The architectural panel may be formed from metal, and the method may start with the processing of a flat metal sheet. The method may include punching holes in a particular pattern into the flat metal sheet, bending the flat metal sheet into a particular shape to form a panel that can be hung from an overhead grid or the like, and printing a desired printing pattern onto the panel. The method may also include a step of coating the panel with a powder coating or a liquid-applied paint finish prior to the printing step. The coating step may occur after the punching step and before the printing step.

### CROSS-REFERENCE TO RELATED APPLICATIONS

The present application claims priority to U.S. Provisional Patent Application Ser. No. 63/223,737, filed on Jul. 20, 2021, the entirety of which is incorporated herein by reference.

### BACKGROUND

Architectural panels serve several different purposes for an interior space. First, they provide a desired aesthetic. Second, they enhance the acoustics within a room. And third, they can be used to control light dispersion within a space, which can improve the aesthetics and also usability of the space. Architectural panels formed from metal have traditionally had limitations with regard to surface finishes and therefore aesthetic capabilities. Thus, a need exists for an architectural panel and a method of manufacturing the same that overcomes the deficiencies of the prior art.

### BRIEF SUMMARY

The present invention may be directed to a method for manufacturing an architectural panel and an architectural panel made by the method. The architectural panel may be formed from metal, and the method may start with the processing of a flat metal sheet. The method may include punching holes in a particular pattern into the flat metal sheet, bending the flat metal sheet into a particular shape to form a panel that can be hung from an overhead grid or the like, and printing a desired printing pattern onto the panel. The method may also include a step of coating the panel with a powder coating or a liquid-applied paint finish prior to the printing step.

In one aspect, the invention may be a method for manufacturing an architectural panel, the method comprising: positioning a flat metal sheet on a punching machine and punching a plurality of holes into the flat metal sheet using one or more punching tools of the punching machine to create a punch pattern in the flat metal sheet; bending the flat metal sheet to form a panel comprising a display portion having an inner surface and an outer surface and one or more sidewall portions extending from the inner surface of the display portion; printing a print pattern onto the outer surface of the display portion of the panel; and wherein at least one of: (1) the flat metal sheet is coated with a powder coating or a liquid-applied paint finish prior to positioning the flat metal sheet on the punching machine; and (2) the panel is coated with the powder coating or the liquid-applied paint finish after bending the flat metal sheet to form the panel and prior to printing the print pattern onto the outer surface of the display portion of the panel

In another aspect, the invention may be a method for manufacturing an architectural panel, the method comprising the following steps being performed sequentially: punching a plurality of holes into a flat metal sheet using one or more punching tools of a punching machine to create a punch pattern in the flat metal sheet; bending the flat metal sheet to form a panel comprising a display portion having an inner surface and an outer surface and one or more sidewall portions extending from the inner surface of the display portion; coating the panel with a powder coating or a liquid-applied paint finish so that the coating covers at least the outer surface of the panel and edges of the panel which surround the holes; applying an adhesion promoter onto the powder coating at least along the display portion of the panel to form a layer of the adhesion promoter that covers the powder coating; and printing an ink onto the layer of the adhesion promoter in a print pattern.

In yet another aspect, the invention may be an architectural panel formed from a flat metal sheet, the architectural panel comprising; a display portion comprising an inner surface and an outer surface; a sidewall portion extending from the inner surface of the display portion in a direction away from the outer surface of the display portion, the sidewall portion comprising an inner surface and an outer surface, the inner surface of the sidewall portion and the inner surface of the display portion collectively forming a cavity; a coating covering at least the outer surface of the display portion and the outer surface of the sidewall portion; a plurality of holes formed through the display portion from the outer surface of the display portion to the inner surface of the display portion, the plurality of holes collectively forming a punch pattern; and a plurality of markings printed onto the outer surface of the display portion, the plurality of markings collectively forming a print pattern.

In still another aspect, the invention may be a method for manufacturing an architectural panel, the method comprising: punching a plurality of holes into a flat metal sheet to create a punch pattern in the flat metal sheet; bending the flat metal sheet to form a panel comprising a display portion and one or more sidewall portions; coating the panel with a powder coating or a liquid-applied paint finish; and printing a print pattern onto the display portion of the panel.

In a further aspect, the invention may be a method for manufacturing an architectural panel, the method comprising: punching a plurality of holes into a flat metal sheet to create a punch pattern in the flat metal sheet; bending the flat metal sheet to form a panel comprising a display portion and one or more sidewall portions; coating the panel with a powder coating or a liquid-applied paint finish; and printing a print pattern onto an outer surface of the display portion of the panel.

In a still further aspect, the invention may be a method for manufacturing an architectural panel, the method comprising: punching a plurality of holes into a flat metal sheet that is pre-coated with a powder coating or a liquid-applied paint finish to create a punch pattern in the flat metal sheet; bending the flat metal sheet to form a panel comprising a display portion and one or more sidewall portions; and printing a print pattern onto an outer surface of the display portion of the panel

In a yet further aspect, the invention may be a method for manufacturing an architectural panel, the method comprising: punching a plurality of three-dimensional shapes into a flat metal sheet; and bending the flat metal sheet to form a panel comprising a display portion and one or more sidewall portions so that protruding features of the three-dimensional shapes protrude from an outer surface of the display portion.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The foregoing summary, as well as the following detailed description of the exemplary embodiments, will be better understood when read in conjunction with the appended drawings. It should be understood, however, that the invention is not limited to the precise arrangements and instrumentalities shown in the following figures:

FIG. 1 is flow chart describing a method of manufacturing an architectural panel in accordance with an embodiment of the present invention;

FIG. 2 is a schematic diagram illustrating a computer in electronic communication with a printer and a punching machine;

FIG. 3 is a perspective view of a flat metal sheet prior to it being manufactured into an architectural panel in accordance with embodiments of the present invention;

FIG. 4 is a perspective view illustrating the flat metal sheet of FIG. 3 positioned on a punching machine that is configured to punch holes into the flat metal sheet in accordance with a punch pattern;

FIG. 4A is a perspective view of a male punching die and a female punching die in accordance with a non-limiting embodiment of the present invention;

FIG. 5 is a perspective view of the flat metal sheet after the holes have been punched therein;

FIG. 6 is a perspective view of a panel formed by bending the flat metal sheet of FIG. 5 in a particular manner;

FIG. 7 illustrates a spray coating being applied onto the panel of FIG. 6;

FIG. 8 illustrates the panel of FIG. 7 being loaded onto a printer whereby a print pattern can be printed onto a surface of the panel;

FIG. 9 is a close-up view illustrating the printer printing the print pattern onto the surface of the panel;

FIG. 10 is a perspective view of the panel of FIG. 9 with the holes therein in accordance with the punch pattern and with markings or indicia thereon in accordance with the print pattern;

FIG. 11A is a rear perspective view of the panel of FIG. 10 with an acoustic back backer;

FIG. 11B is a rear perspective view of the panel of FIG. 10 with a translucent backer;

FIG. 12 is a perspective view illustrating a plurality of the panels of FIG. 10 being coupled to an overhead grid system to form a suspended ceiling;

FIG. 13 is a front view of a plurality of the panels of FIG. 10 arranged in a side-by-side manner to illustrate the cohesiveness of the punch and print patterns thereon;

FIGS. 14-18 are perspective views of panels in accordance with embodiments of the present invention whereby the panels have different punch and print pattern than the prior embodiments;

FIG. 19 is a top plan view of an architectural panel with a three-dimensional punch pattern in accordance with another embodiment of the present invention;

FIG. 20 is a cross-sectional view taken along line XX-XX of FIG. 19; and

FIGS. 21A-21C are top and bottom perspective views and a front view, respectively, of punching dies used to form a three-dimensional punch pattern in accordance with an embodiment of the present invention.

### DETAILED DESCRIPTION

The following description of the preferred embodiment(s) is merely exemplary in nature and is in no way intended to limit the invention, its application, or uses.

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “left,” “right,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the preferred embodiments. Accordingly, the invention expressly should not be limited to such preferred embodiments illustrating some possible non-limiting combinations of features that may exist alone or in other combinations of features; the scope of the invention being defined by the claims appended hereto.

Features of the present invention may be implemented in software, hardware, firmware, or combinations thereof. The programmable processes described herein are not limited to any particular embodiment, and may be implemented in an operating system, application program, foreground or background processes, driver, or any combination thereof. The computer programmable processes may be executed on a single processor or on or across multiple processors.

Processors described herein may be any central processing unit (CPU), specialized processing unit (e.g., a graphics processing unit), microprocessor, micro-controller, computational, or programmable device or circuit configured for executing computer program instructions (e.g. code). Various processors may be embodied in computer and/or server hardware of any suitable type (e.g. desktop, laptop, notebook, tablets, cellular phones, etc.) and may include all the usual ancillary components necessary to form a functional data processing device including without limitation a bus, software and data storage such as volatile and non-volatile memory, input/output devices, graphical user interfaces (GUIs), speakers, microphones, removable data storage, and wired and/or wireless communication interface devices including Wi-Fi, Bluetooth, LAN, etc.

Computer-executable instructions or programs (e.g. software or code) and data described herein may be programmed into and tangibly embodied in a non-transitory computer-readable medium that is accessible to and retrievable by a respective processor as described herein which configures and directs the processor to perform the desired functions and processes by executing the instructions encoded in the medium. A device embodying a programmable processor configured to such non-transitory computer-executable instructions or programs is referred to hereinafter as a “programmable device,” or just a “device” for short, and multiple programmable devices in mutual communication is referred to as a “programmable system.” It should be noted that non-transitory “computer-readable medium” as described herein may include, without limitation, any suitable volatile or non-volatile memory including random access memory (RAM) and various types thereof, read-only memory (ROM) and various types thereof, flash memory, and magnetic or optical data storage devices (e.g. internal/external hard disks, floppy discs, magnetic tape CD-ROM, DVD-ROM, optical disk, ZIP™ drive, Blu-ray disk, and others), which may be written to and/or read by a processor operably connected to the medium.

In certain embodiments, the present invention may be embodied in the form of computer-implemented processes and apparatuses such as processor-based data processing and communication systems or computer systems for practicing those processes. The present invention may also be embodied in the form of software or computer program code embodied in a non-transitory computer-readable storage medium, which when loaded into and executed by the data processing and communications systems or computer systems, the computer program code segments configure the processor to create specific logic circuits configured for implementing the processes.

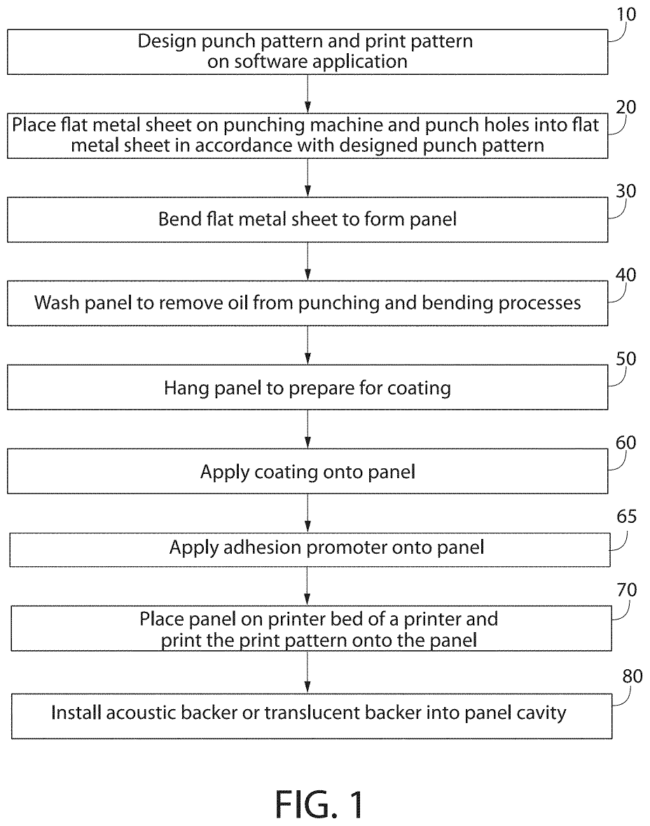

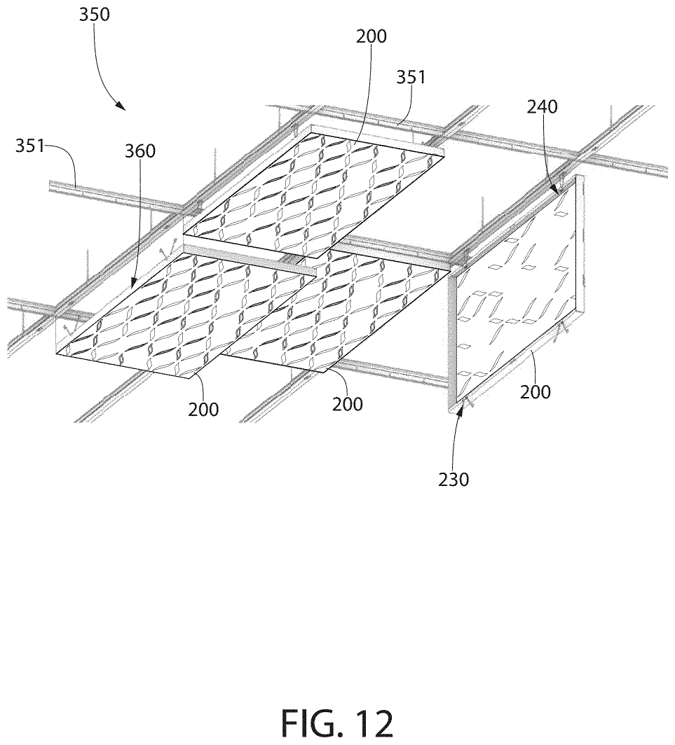

Referring first to FIG. 1, a flow diagram of a method of manufacturing an architectural panel is provided. Prior to describing the method, a brief discussion of the architectural panels will be provided. The architectural panels are panels that are intended to be mounted to an existing ceiling or to an overhead grid assembly so that the architectural panels form a ceiling, such as and including a suspended ceiling. Alternatively, the architectural panels may be mounted to a wall to form a desirable aesthetic along the walls of an interior space. The architectural panels may be mounted to a wall and to a ceiling to form a seamless interior space with a seamless transition between the wall and ceiling. The architectural panels may have desirable acoustic properties to enhance the acoustics within the interior space, and may have desirable aesthetic features as described herein. The architectural panels are generally designed and intended for use in interior spaces, but may also be used on exterior surfaces of buildings. Such architectural panels are generally manufactured at a manufacturing site and then shipped to a desired location where they are installed by an installer. The installer may either affix the architectural panels directly to an existing wall or ceiling, or may mount them to an overhead grid system such as the one shown in FIG. 12 and described below. In the exemplified embodiment, the architectural panels are preferably formed from metal, such as including without limitation aluminum, stainless steel, galvanized steel, brass, cold rolled steel, hot rolled steel, tinplate, and copper. Of course, other materials may be used in other embodiments. Acoustical backers or the like may be attached to the metal panel to enhance acoustic properties thereof and to enhance the acoustics within the interior space at which the architectural panels are mounted. Translucent backers may be attached to the metal panel to enhance light transmission through the panels and in some instances to dull the light as may be desired.

The method of manufacturing the architectural panel in accordance with the invention set forth herein includes steps associated with punching holes in accordance with a hole pattern into the architectural panel and printing a print pattern onto the architectural panel. The arrangement of the hole pattern and the print pattern may result in a cohesive aesthetic as the hole pattern and the print pattern may have similarities in their elements and overall patterns. The punch and print patterns may have a cohesive effect, in that while the patterns are different, they are similar and overlap one another to create a cohesive aesthetic on the panel formed by a combination of the holes and the printed elements/features. Of course, this is not required in all embodiments, but some embodiments which include this cohesiveness between the print and hole patterns will be described herein.

An embodiment of the method of manufacturing the architectural panel will now be described with reference to FIG. 1. The method may include the following steps: step 10, designing the punch pattern and the print pattern on a software application; step 20, placing a flat metal sheet on a punching machine and punching holes into the flat metal sheet in accordance with the punch pattern designed at step 10; step 30, bending the flat metal sheet to form an architectural panel; step 40, washing the panel to remove oil from the punching and bending processes; step 50, hanging the panel to prepare for coating; step 60, applying a coating onto the panel; step 65, applying an adhesion promoter onto the panel; step 70, placing the panel on a printer bed of a printer and printing the print panel onto the panel; and step 80, installing an acoustic backer or a translucent backer into a panel cavity of the panel. In some embodiments, one or more of these steps may be omitted. In some embodiments, some of these steps may occur in an order which is different than that which is shown and described.

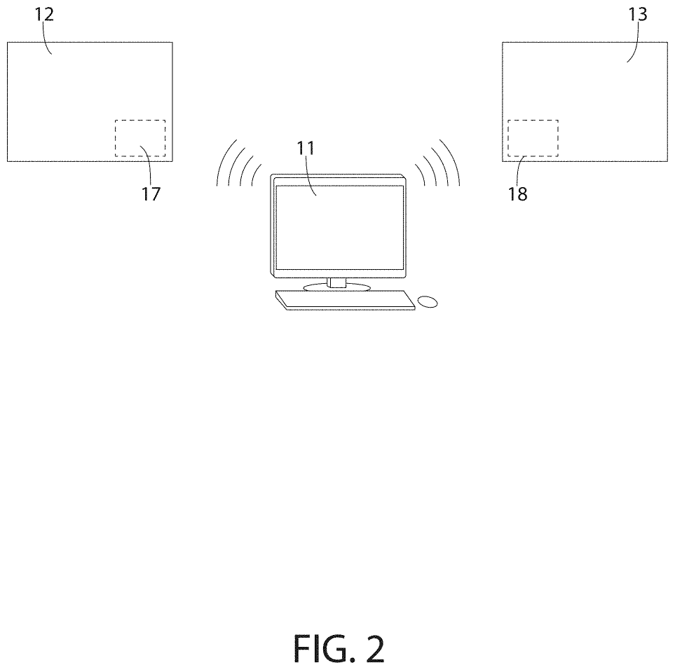

These steps will be described in greater detail below with reference to FIG. 1 alone or in conjunction with one or more of FIGS. 2-11B. Some variation in the order of the steps and the possible omission of certain steps in the manufacture of the architectural panels will also be explained in the detailed description of the manufacturing process that follows. In some embodiments, after the aforementioned steps, a clear coat finish may be applied to the finished panel as a protective coating. The clear coat finish may be applied only onto a surface of the panel that is intended to be visible after installation, or it may be applied onto the entirety of the panel. The clear coat finish may be a paint applied product or a resin with no pigments that imparts no color to the panel while providing a layer of protection to the panel.

Referring to FIGS. 1 and 2, as noted above the first step in the process is to design a punch pattern and a print pattern on a software application. In particular, a user may design a pattern of holes to be punched into the architectural panel using a software application, such as a computer-aided design software package that is running on a computer 11. Separately, or within the same software application, the user may design a pattern of markings to form the print pattern. That is, the print pattern may be designed on the same computer-aided design software as the punch pattern, or they may be separately designed. Designing them together may help to ensure that the end-result design is cohesive and will provide the desired aesthetic. In particular, the print and punch patterns may include principles of design work together, such as contrast, balance, emphasis, movement, white space, proportion, hierarchy, repetition, rhythm, pattern, unity, and variety, to create an architectural panel that is aesthetically pleasing and optimizes the user experience.

Once the punch and print patterns have been designed on the software application, the software application may be executed in a punching machine to punch holes into the panel in accordance with the pre-designed hole pattern. Furthermore, the software application may be executed on a printer to print a design onto the panel in accordance with the print pattern. That is, the punching machine and the printing machine may separately receive inputs containing data associated with the punch and print patterns so that those machines may apply the print and/or punch patterns onto the architectural panel at the appropriate time during the manufacturing process.

In FIG. 2, the computer 11 is illustrated in operable communication with a generically illustrated punching machine 12 and a generically illustrated printing machine 13. Each of the punching machine 12 and the printing machine 13 may also contain its own internal computer or processor 17, 18 that is configured to receive the input from the computer 11. After the punch and print patterns are designed on one or more software applications running on one or more computers (such as the computer 11), inputs associated with the punch pattern may be transmitted to and received by the punching machine 12 and inputs associated with the print pattern may be transmitted to and received by the print machine or printer 13. That is, the inputs will be received by the computers/processors 17, 18 of the punching and printing machines 12, 13 so that those machines can execute the code associated with the design patterns. Specifically, those inputs are transmitted from the computer 11 to the punching and printing machines 12, 13 (and more specifically to the computers/processors 17, 18 thereof), with the inputs containing data associated with the print and punch patterns. A flat metal sheet may then be positioned on the punching machine so that the punching machine can execute the input associated with the punch pattern to punch holes in the flat metal sheet in accordance with the punch pattern. At a later stage in the manufacturing process, perhaps after the flat metal sheet has been bent into a panel shape as described herein, the panel may be positioned on the print machine so that the print machine can execute the input associated with the print pattern to print a design on the panel in accordance with the print pattern. Of course, the sequence of the steps of the manufacturing process will be described in greater detail below, including alternative sequences.

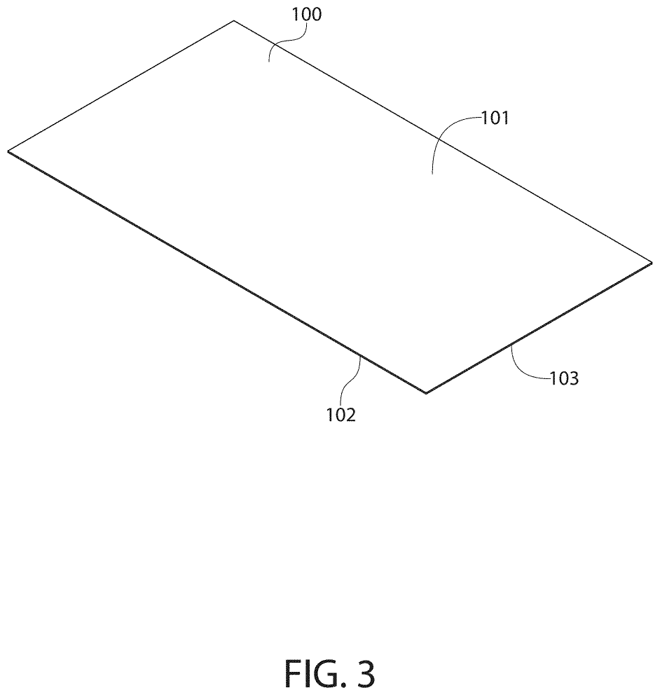

Referring to FIGS. 1, 3, and 4, after the punch and print patterns are designed on the software application, at step 20 a flat metal sheet 100 is positioned on the punching machine 12. The flat metal sheet 100 comprises a first surface 101, a second surface 102 opposite the first surface 101, and an edge 103 extending between the first and second surfaces 101, 102. As noted above, the flat metal sheet 100 may be formed from aluminum, stainless steel, galvanized steel, brass, cold rolled steel, hot rolled steel, tinplate, and copper, combinations thereof, alloys thereof, or the like. In FIG. 3, the flat metal sheet 100 has already been cut to a desired size. However, in other embodiments the flat metal sheet 100 may be fed to the punching machine 12 before the flat metal sheet 100 is cut, such that the flat metal sheet 100 may form a roll of metal sheet material that can be unrolled and fed to the punching machine 12. In such embodiments, the punching machine 12 may be configured to cut the flat metal sheet 100 to a desired size either before or after the punching machine 12 punches holes in the flat metal sheet 100. In some embodiments, it may be preferable to punch the holes first, and then cut the boundary to cut the flat metal sheet 100 to size to prevent the flat metal sheet 100 from coming loose prior to finishing the punching operation. In some embodiments a single flat metal sheet 100 may be large enough to be cut into five panels.

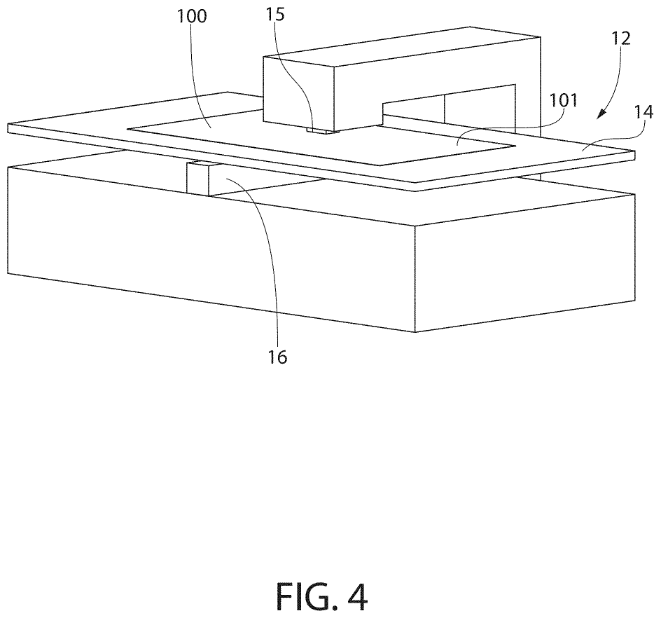

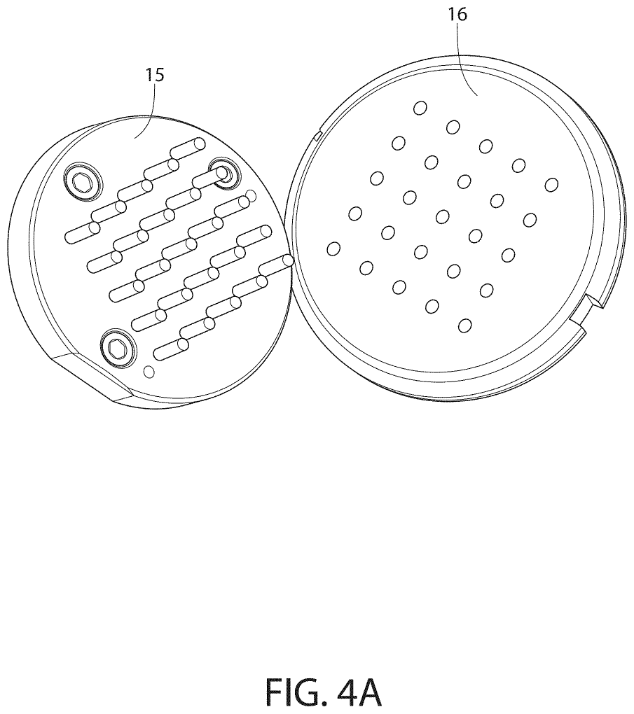

As shown in FIG. 4, the flat metal sheet 100 is positioned on a holding mechanism 14 of the punching machine 12. The holding mechanism 14 may include rollers, robotic arms, or the like configured to move the flat metal sheet 100 in various different directions while holding the flat metal sheet 100 on a single plane (such as a horizontal plane) during a punching operation in order to align different parts of the flat metal sheet 100 with the different punching tools of the punching machine 12. While a specific structure is illustrated for the punching machine 12 for purposes of providing a visual to the reader, it should be appreciated that the structural and functional details of the punching machine 12 are not to be limited to that which is shown in the drawings in all embodiments.

The punching machine 12 may be any machine configured to receive inputs, such as inputs associated with a punch pattern from the computer 11, and execute those inputs to punch holes in the flat metal sheet 100. That is, the punching machine 12 is configured to execute the input it receives from the computer 11 in order to punch holes in the flat metal sheet in accordance with the punch pattern designed at step 10. In the exemplified embodiment, the flat metal sheet 100 is positioned on the holding mechanism 14 of the punching machine 12 so that upon one or more punching tools of the punching machine 12 striking the flat metal sheet 100, holes are formed through the flat metal sheet 100 that extend from the first surface 101 of the flat metal sheet 100 to the second surface 102 of the flat metal sheet 100. Each of the punching tools may comprise a male punching portion 15 and a female receiving portion 16. FIG. 4A provides an illustration of the male and female punching portions 15, 16 which form the punching die. As seen, the male punching portion 15 comprises a plurality of protruding rods and the female punching portion 16 comprises a plurality of holes that are positioned to receive the protruding rods as the male punching portion 15 is moved towards the female punching portion 16. During operation, the male punching portion 15 may be driven downwardly towards the first surface 101 of the flat metal sheet 100 so that the protruding rods of the male punching portion 15 penetrate through the flat metal sheet 100 and are received within the holes of the female receiving portion 16. This action forms the holes in the flat metal sheet 100.

The punching machine 12 may have many different punching tools that can move and/or rotate relative to the flat metal sheet 100 in order to punch the desired hole pattern into the flat metal sheet 100. The punching machine 12 may also move and/or slide and/or translate the flat metal sheet 100 in order to align different parts of the flat metal sheet 100 with different punching tools of the punching machine 12. Thus, the flat metal sheet 100 and the punching tools may be moving at various different times during the punching process in order to punch the holes in the flat metal sheet 100 in accordance with the pre-designed punch pattern designed at step 10.

As noted above, once the punch pattern has been completely punched into the flat metal sheet 100, the flat metal sheet 100 may be cut (if it was not pre-cut as noted above). For example, the flat metal sheet 100 that is initially positioned on the punching machine may be significantly larger in width, length, and/or overall surface area than the desired size of the final architectural panel. In such situations, the flat metal sheet 100 may be cut into the desired size after the punching operation is complete. The punching machine 12 may have the necessary tools and instructions to perform the cutting operation, or another machine may perform the cutting operation, or the flat metal sheet 100 may be manually cut by a user or operator. As noted above, in other embodiments the flat metal sheet may be pre-cut such that it is at a desirable shape and size prior to placing it on the punching machine.

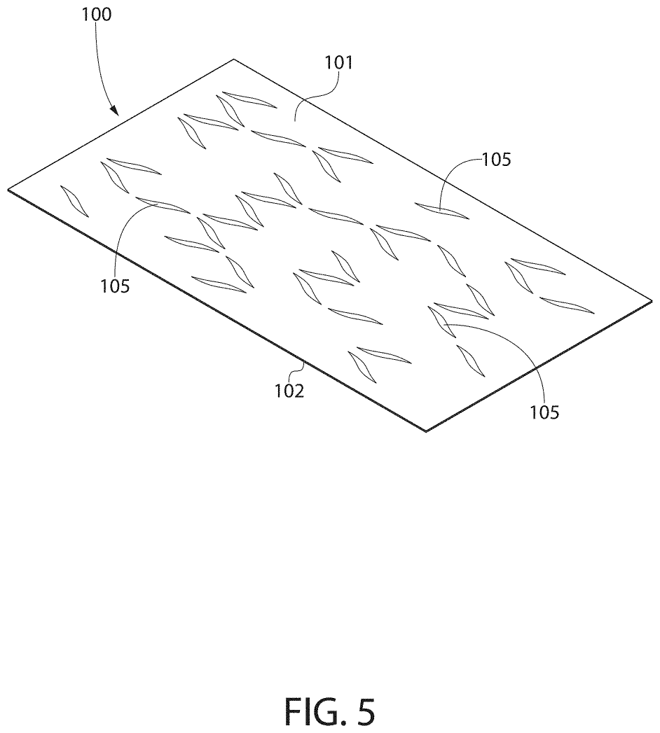

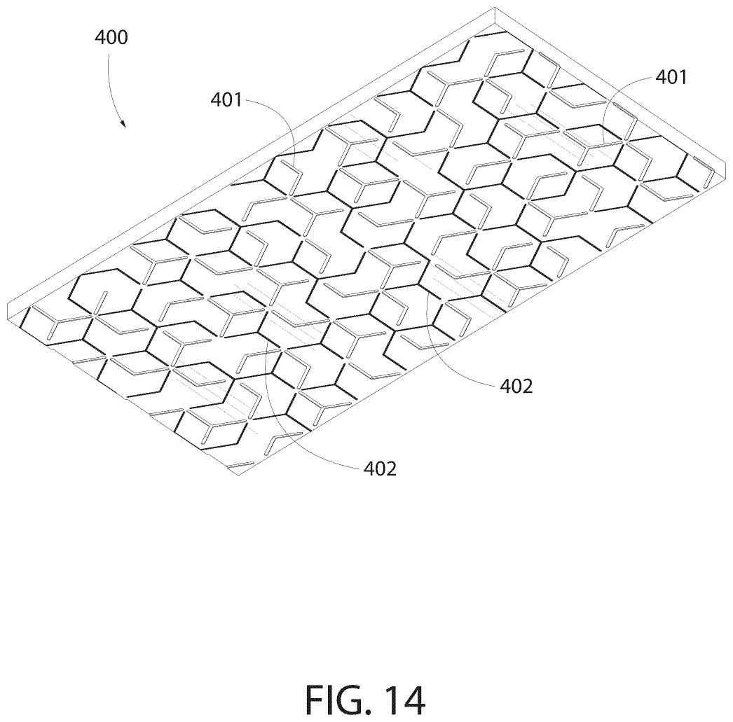

FIG. 5 illustrates the flat metal sheet 100 with a plurality of holes 105 formed therein. As noted above, each of the holes 105 extends through the flat metal sheet 100 from the first surface 101 to the second surface 102. In this embodiment, each of the holes 105 has the same shape, such that each of the holes 105 was formed by a single strike from the same punching tool of the punching machine 12. In other embodiments, the holes may be formed from multiple punching tools having different shapes such that one or more of the holes 105 may have differing shapes from one another. In other embodiments, one or more of the holes 105 may be formed by multiple successive strikes with one of the tools of the punching machine 12. An embodiment of a panel with holes formed in this manner will be described below with reference to FIG. 14. The specific punch pattern is not to be limiting of the present invention in all embodiments unless specifically claimed as such. Thus, the punch pattern and therefore the arrangement of the plurality of holes 105 may differ from that which is shown in the embodiments of the flat metal sheets and architectural panels formed thereby provided in the drawings that form a part of this application.

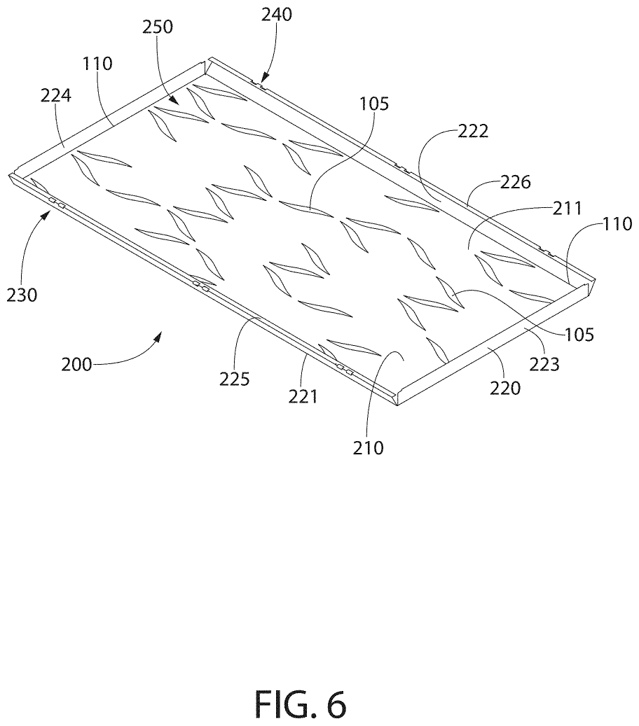

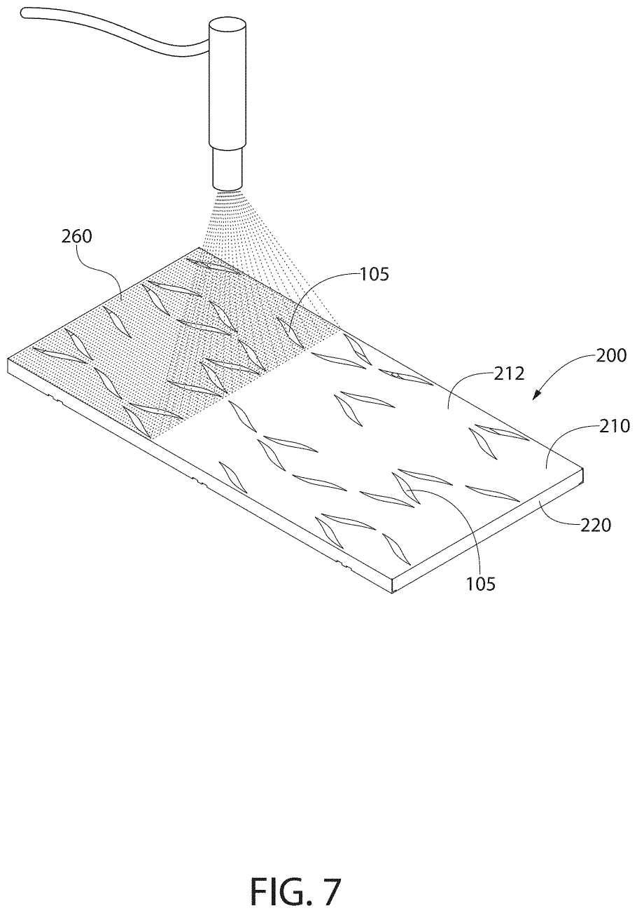

After the plurality of holes 105 are formed into the flat metal sheet 100 in accordance with the punch pattern, the flat metal sheet 100 is bent to form the architectural panel as described at step 30 and shown in FIG. 6. This step may involve the use of a press break, a panel bender, or a robotic folder to bend and/or fold the flat metal sheet into a desired shape so that it can be readily mounted to a wall, or more particularly to an overhead grid assembly as described herein for use as a suspended ceiling. In the exemplified embodiment, the flat metal sheet 100 is bent at four bend locations 110 (two of which are visible and delineated in FIG. 6) to form an architectural panel (i.e., a panel) 200 comprising a display portion 210 and a sidewall portion 220. The display portion 210 comprises an inner surface 211 and an outer surface 212 (shown in FIG. 7), with the outer surface 212 being the surface that is exposed to an interior space when the panel 200 is installed therein. In the exemplified embodiment, the sidewall portion 220 comprises four sidewalls that extend from the inner surface 211 in a direction away from the outer surface 212. Of course, the number of sidewalls that form the sidewall portion 220 may be modified depending on the final overall shape of the panel 200 desired or needed for a particular installation.

Thus, the sidewall portion 220 comprises a first portion 221, a second portion 222, a third portion 223, and a fourth portion 224. In the exemplified embodiment, the panel 200 is further bent during the bending step so that first and second flanges 225, 226 extend inwardly from distal ends of the first and second portions 221, 222 of the sidewall portion 220 (with the first and second portions 221, 222 of the sidewall portion 220 being positioned opposing one another and not adjacent to one another). A plurality of pairs of slots 230 are formed into the first sidewall 221 and the first flange 225. Another plurality of pairs of slots 240 are formed into the second sidewall 222 and the second flange 226. Each of the slots 230 extends continuously along the first sidewall 221 and the first flange 225. Each of the slots 240 extends continuously along the second sidewall 222 and the second flange 226. The pairs of slots 230, 240 are configured to receive torsion springs therein which facilitates the attachment of the panels 200 to an overhead grid assembly when the panels 200 are used to form a suspended ceiling, as shown in FIG. 12. The sidewall portion 220 and the display portion 210 collectively define a rear cavity 250 of the panel 200.

In this embodiment, the holes 105 are located entirely along the display portion 210 of the panel 200. However, the invention is not to be so limited and in other embodiments the holes 105 are positioned so that when the flat metal sheet 100 is bent to form the panel 200, some of the holes 105 extend continuously along the display portion 210 and a part of the sidewall portion 220, including extending through the corner where the sidewall portion 220 intersects the display portion 210 (i.e., along the bend locations 110). This can help to maintain a seamless aesthetic when multiple of the panels 200 are arranged in a side-by-side manner. Specifically, the holes 105 of two adjacent panels 200 that extend along the display and sidewall portions 210, 220 of those panels 200 may be aligned with each other to form a singular closed geometry shaped hole when viewed by a user in the interior space at which the panels 200 are installed.

Next, at step 40, the panel 200 that was formed at step 30 as illustrated in FIG. 6 may be washed to remove oil from the punching and bending processes. Step 40 may be omitted in some embodiments if there is no oil to be removed or if oil removal is unnecessary.

At step 50, the panel 200 that was formed at step 30 and potentially washed at step 40 may be hung to prepare the panel 200 for a coating application. For example, the panel 200 may be hung on a hook or a drying rack or the like to dry after the washing step, and hung in a manner that allows for a coating (either a powder coating or a liquid-paint coating) to be applied thereon.

Next, referring to FIGS. 1 and 7, at step 60 a coating 260 may be applied onto the panel 200. The coating 260 may be applied as a powder coating or a liquid-paint coating that is applied directly to the panel 200. FIG. 7 illustrates a liquid-paint applied coating in accordance with one embodiment (sprayed on). The liquid paint coating may be applied in other ways, such as using a paintbrush, in other embodiments. A powder coating may be applied in the alternative, such as by applying the powder coating electrostatically and then allowing it to cure under heat or with ultraviolet light as is generally understood by those skilled in the art. In such embodiments, the powder may be a thermoplastic or a thermoset polymer. In either case, the coating 260 applies a paint-like finish onto the panel 200.

In an exemplary embodiment, a powder coating composition is used to coat the panel. The powder coating composition may comprise one or more of Epoxy-Based Powder Coatings, Acrylic Powder Coatings, Hydroxyl, and Carboxyl Polyester Powder Coatings

Regardless of the manner in which the coating is applied onto the panel 200, the coating may be any desired color, although a white coating may be preferable in some embodiments. The coating 260 may be applied so as to cover all of the surfaces of the panel 200, including the inner and outer surfaces 211, 212 of the display portion 210 of the panel 200 and the inner and outer surfaces of the sidewall portion 220 of the panel 200. In other embodiments, the coating 260 may only be applied onto the outer surface 212 of the display portion 210 and the outer surface of the sidewall portion 220, since those are the surfaces that are visible when the panel 200 is installed in an interior space. In the exemplified embodiment, the coating 260 may be applied so that it coats the interior edges of the panel 200 which define or surround the various holes 105 that were punched therein at step 20. This ensures that all visible surfaces/edges of the panel 200 are coated prior to installation at the installation site.

While in the exemplified embodiment the panel 200 is coated after being formed by bending and after the holes are punched therein, this is not required in all embodiments. In other embodiments, the flat metal sheet 100 may be pre-coated such that the flat metal sheet 100 is coated prior to punching the holes as described above with reference to step 20. In such embodiments, steps 50 and 60 may be omitted. In other embodiments, even if the flat metal sheet 100 is pre-coated, a coating step may still be applied after bending the flat metal sheet 100 into the panel 200 and after punching the holes into the panel 200. Specifically, during the bending process the coating may chip away at the bend locations or become otherwise impaired. Furthermore, as noted above the hole punching may create uncoated edges surrounding the holes that are visible to a user at the installation site. Thus, even with a pre-coated flat metal sheet, it may be desirable to include the coating at step 60 in order to coat the panel 200 at the bend locations and to coat the previously uncoated edges that surround the holes 105 in the panel 200.

Next, referring to FIG. 1 at step 65, an adhesion promoter layer may be applied onto the outer surface 212 of the display portion 210 to improve the adherence of the ink of which occurs at step 70 and is described below. That is, the adhesion promoter layer may enhance ink adhesion performance during the printing step 70. In particular, during the manufacturing process, it was discovered that the ink used during the printing process of step 70 did not consistently adhere to the coating applied at step 60. As such, the printed design from the ink had a tendency to chip away over time or simply not adhered adequately to the panel. Thus, after some trial and error, it was determined that the addition of an adhesion promoter layer onto the coating on the panel prior to printing the ink design on the panel resulted in a better adherence of the printed ink onto the panel. The adhesion promoter material may comprise resins of polymeric compounds, such as for example without limitation acrylic resins, polyvinylidene resins, photosensitive resins, polyurethane resins or the like.

During step 65, the panel may be hung on a hook and the adhesion promotor composition may then be applied onto the panel. In other embodiments the panel may be positioned on a drying rack or any other flat or horizontal surface, in a manner that allows for applying the promoter layer onto the outer surface 212 of the display portion of the panel 210. The adhesion promoter layer may be applied onto the panel in any of a variety of different ways, including painting or spraying the composition onto the outer surface 212 of the display portion 210 of the panel 200 or dipping the panel 200, or at least the outer surface 212 thereof, into a source of the adhesion promotor material. Regardless of the manner of application, step 65 results in a layer of an adhesion promoter material or composition being applied onto the outer surface 212 of the panel 200. In some embodiments, the adhesion promoter may be applied in spray format, using the same location used for the coating at step 60. The adhesion promoter layer may be desirable in instances in which the powder coating provides a low adhesion to the ink during the printing at step 70. Thus, the adhesion promoter layer may be better able to adhere to the ink than the coating material

Next, referring to FIGS. 1, 8 and 9, the indicia or markings or print elements or the like may be printed onto the panel 200 to create the finished product. At step 70, the panel 200 is positioned on a printer bed 301 of a printer 300 so that the print pattern designed in step 10 can be printed onto the panel 200. The panel 200 is preferably positioned on the printer 300 so that the outer surface 212 of the display portion 210 of the panel 200 is facing a print head 302 of the printer 300. This is because the print pattern is intended to be printed onto the outer surface 212 of the display portion 210 of the panel 200, which is the surface of the panel 200 that is exposed and visible to people gathered within the interior space at which the panel 200 is installed. The printer may print an ink design onto the panel. More specifically, the ink design may be printed onto the coating layer, or onto the adhesion promoter layer.

The ink that is printed on the panel may be an ultraviolet (“UV”) ink. The ink may be an ultraviolet curable ink. Ultraviolet curable inks may include photoinitiators, monomers, oligomers, colorants, and additives.

In starting and completing the UV-curing process, photoinitiators may be the prime components. After absorbing UV energy from the light source located on the print head, the photoinitiators may fragment into reactive materials that start a chemical reaction known as polymerization. The process converts the liquid ink into a solid film. The types of photoinitiators most commonly used in inkjet inks have been of the free-radical nature. The inks may be developed to ensure compatibility with the UV output of medium-pressure, mercury-vapor and/or LED bulbs found in most curing systems for inkjet printing.

Monomers may provide certain within an inkjet formulation, depending on their viscosity and chemistry. Mono-functional monomers may be used as “solvents,” or flow modifiers, because of their ability to reduce viscosity and combine with other ink components. Monomers may be 100 percent solids and may not release VOCs. Monomers may also pass on an ink's surface characteristic. After curing, the monomer may become a part of the polymer matrix. Monomers may also provide more “functionalities.” Monomers may come in mono, di, tri, tetra, penta, etc., functionalities. These “higher functions” of a monomer add improved film hardness and resistance properties, but may also increase the viscosity of the chemistry.

Oligomers may have a high molecular weight and form the chemical spine of a UV-curable ink. Oligomers may determine the final properties of the cured ink film, including its elasticity, outdoor performance characteristics and chemical resistance.

Colorants in UV inkjet inks can be dye-based or pigment-based. Usually, the colorant is pigment-based because of the greater light fastness and durability of pigments compared with dyes. Pigments used in outdoor advertising and display applications have similar requirements to those used in automotive paints. Consequently, there is some crossover of use. While a pigment is selected on the basis of the required application, size control and reduction along with dispersion technique are major components of ink formulation.

Depending on the UV ink formulation, other additives can also be included, such as flow and wetting aids, antioxidants and stabilizers. Surfactants (surface active agents) may be included to ensure the ink film spreads in a controlled fashion, and coats the media or substrate uniformly. Careful control of drop-spreading behavior may contribute to the dot-gain control, which may be important for image quality. Stabilizers may be used to help with the ink's shelf-life and increase the tolerance to heat, which is important at higher jetting temperatures. Simplistically, stabilizers may neutralize or absorb reactive molecules in the ink during storage and prevent polymerization.

Alternatively, the ink that is printed onto the panel may be a dye sublimation ink, such as an aqueous dye sublimation ink and a solvent dye sublimation ink. In aqueous dye sublimation ink, water may be the solvent in which the pigments and other ingredients are suspended. An exemplary dye sublimation ink may have a composition comprising Water 30-95%, Dye particles 1-10%, Co-solvent such as glycerol, propylene glycol, and dipropylene glycol 5% to 40%., and Biocide such as Proxel GXL as a preservative, at 0.01% to 5%.

Solvent dye sublimation inks may be pigments suspended in an oil base, although other stabilizers and surfactants may also be included. Solvent inks may contain a chloride-vinyl acetate copolymer at 2-6%, polymeric amide at 0-4%, ethyl acetate at 0-4%, 2-methoxy-1-mthylethyl at 0-1.25%, N-butyl acetate at 0-2.5%, and Butan-2-OL at 0-0.5% distillate at 0-3%, Propylene glycol must be included in the range of 0% to 2%, and an additional acetate may make up 78% to 95% of the solution. This entire solvent based dye sublimation ink solution should be able to flow through the head of an ink jet printer in order to function properly.

In this embodiment, the printer bed 301 comprises a grid 310 with a plurality of coupling elements 311 arranged therealong in columns and rows. In the exemplified embodiment, the coupling elements 311 are cavities or female features, but the invention is not to be so limited in all embodiments and the coupling elements 311 may take on other structural forms so long as they are capable of performing the function described herein. Furthermore, there may be a vacuum fixture 320 comprising an air compressor 321 and a plurality of suction elements 322 that are operably coupled to the air compressor 321. Thus, when the air compressor 321 is powered, each of the plurality of suction elements 322 may perform a suction or vacuum action to securely hold the panel 200 thereon. Each of the suction elements 322 comprises a coupling element (not visible) which cooperates with the coupling elements 311 of the grid 310 to couple the suction elements 322 to the grid 310 of the printer bed 301. Thus, in accordance with the exemplified embodiment, the coupling elements of the suction elements 322 may be posts that are inserted into the cavity of the coupling element 311 of the grid 310. Furthermore, in other embodiments the suction elements 322 may comprise cavities and the grid 310 may comprise posts that mate with the cavities for coupling the suction elements 322 to the grid 310. In either situation, the suction elements 322 are detachably coupled to the grid 310 at any of a plurality of different locations along the grid 310. Specifically, the suction elements 322 can be positioned at any location at which the grid 310 comprises a coupling element 311, thereby allowing the suction elements 322 to be positioned in any of a variety of different arrangements. This allows the suction elements 322 to be arranged in an optimal arrangement depending on the size of the panel 200 and the locations of the holes 105 formed into the panel 200. For example, it is preferable that the suction elements 322 are aligned with portions of the panel 200 that do not have holes in order to ensure that the suction/vacuum is applied onto the solid material of the panel 200 rather than through the holes 105, which would not serve to securely hold the panel 200 in place. In some embodiments, the vacuum fixture or other features of the printer bed may cover some or all of the holes that were previously formed into the panel 200 in order to enhance the suction/vacuum applied thereto.

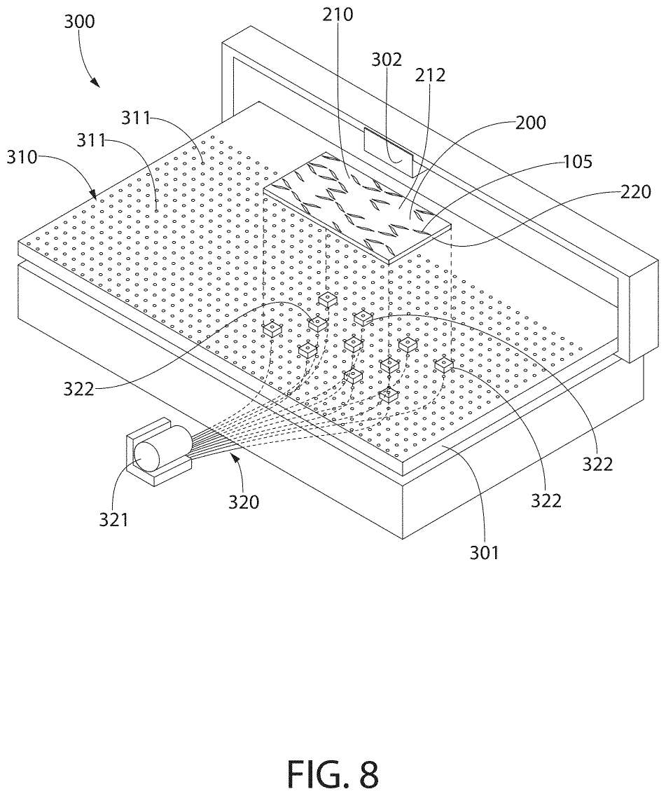

As shown in FIG. 8, the panel 200 is placed onto the printer bed 301 with the inner surface of the display portion 210 facing the printer bed 301 and the outer surface 212 of the display portion 210 facing away from the printer bed 301. When the panel 200 is so positioned, the suction elements 322 are disposed within the cavity 250 of the panel 200. When the air compressor 321 is activated, the suction elements 322 apply suction/vacuum onto the panel 200 which serves to hold the panel 200 securely in place on the printer bed 301. It may be possible to secure more than one panel 200 onto the printer bed 301 at a time to print onto more than one panel at a time, depending on size requirements and the like.

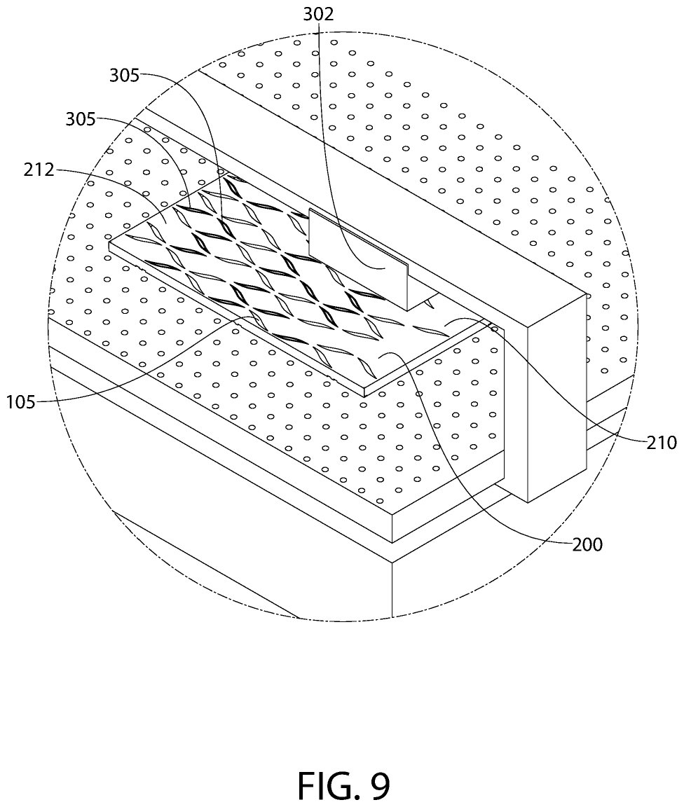

Next, as shown in FIG. 9, the print head 302 of the printer 300 may move along or across the panel 200 to apply the print pattern onto the outer surface 212 of the display portion 210 of the panel 200. The print head 302 may be coupled to a gantry 303 that is configured to move in a first axial direction while the print head 302 is configured to move along the gantry 303 in a second axial direction that is perpendicular to the first axial direction. This will allow the print head 302 to access the entire outer surface 212 of the display portion 210 of the panel 200. As seen in FIG. 9, the suction elements 322 are not visible because they are hidden behind the panel 200. However, as the printer 300 is operating to print the print design onto the panel 200, the suction elements 322 are activated (due to the activation of the air compressor 321 as previously described) to hold the panel 200 in place. The printer 300 may print onto the panel 200 using an ultraviolet (UV) printing technique, a dye-sublimation printing technique, a digital printing technique, or any other printing technique known to be effective for printing onto a metal panel formed from one or more of the materials described herein and/or coated as described herein. The printer 300 may be a digital printer in some embodiments.

In one embodiment, the UV printing technique may be used to print the ink design pattern onto the panel 200. In such embodiments, the print head may apply the ink onto the outer surface 212 of the display portion of the panel 200, and as the ink is distributed specially designed UV lights may follow closely behind, curing the ink instantly. This UV curing process is based on a photochemical reaction, using light instead of conventional curing with heat. Liquid monomers and oligomers are mixed with a small percentage of photo initiators and are exposed to UV-light as an energy source. The ink hardens instantly. This hardening is triggered by photo initiators, which absorb light of certain wavelengths and transfer this energy to the binding system molecules.

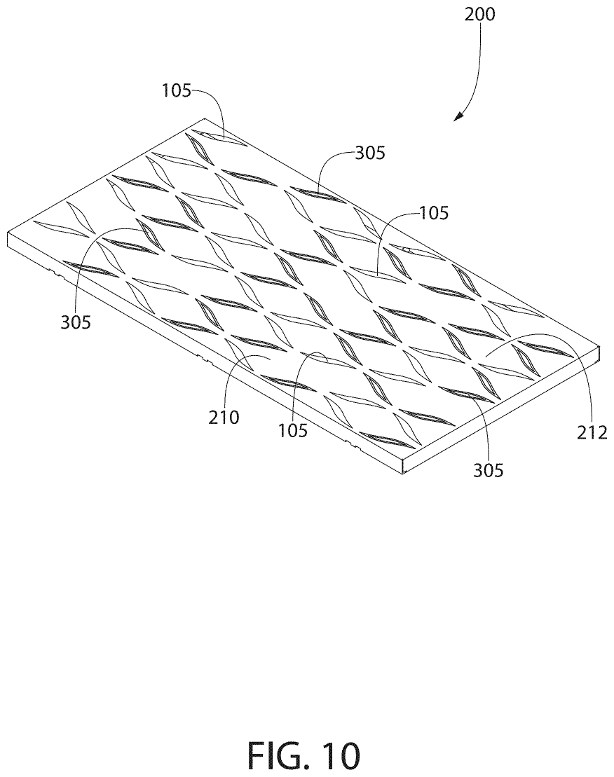

In the embodiment (see, for example, FIGS. 9 and 10), the print pattern that is printed onto the panel 200 comprises a plurality of markings or indicium or “print elements” 305 that match the shape of the holes 105 that are formed into the panel 200. Thus, in some embodiments the print elements 305 and the holes 105 have the same shape. The term “the same shape” includes situations where the print elements 305 and the holes 105 have different dimensions, so long as the general shape is the same. FIG. 9 illustrates the panel 200 with the holes 105 and with much of the print pattern completed such that there are a plurality of the markings or indicium 305 also printed onto the panel 200. As seen, the holes 105 and the markings/indicium 305 have a cohesive appearance such that it is somewhat difficult to determine which markings are the holes 105 and which are the printed markings 305. This combination of features that have a similar shape including both printed indicia 305 and holes 105 through which light may be dispersed creates an aesthetic that is beautiful and desirable. The printed markings/indicia 305 may have the same color (black, blue, red, yellow, etc.), or there may be different printed markings/indicia with different colors. Comparing FIG. 5 with FIG. 9 illustrates which of the markings are printed and which are holes. The number of holes and printed design elements may match, or there may be more holes than printed design elements or more printed design elements than holes. Thus, there is a lot of variation possible in accordance with the embodiments of the invention as disclosed herein.

As noted above, the panel 200 may be pre-coated, or a coating may be applied after the holes are punched and before the printing is applied. It is important that the coating be applied before the printing is applied, because otherwise the coating may cover some or all of the markings/indicia of the print pattern. Thus, the flat metal sheet 100 may be pre-coated, or the coating can be applied to the flat metal sheet 100 or the panel 200 either before or after the holes are punched therein, but always before the print pattern is printed thereon. In one preferred embodiment, the panel 200 is coated after the holes are punched therein and before the print pattern is printed thereon so that the coating can cover all exposed surfaces/edges as described herein and the print pattern can be printed onto the coating.

FIG. 10 illustrates the panel 200 after the printing operation has been completed. As discussed, the panel 200 has the plurality of holes 105 formed therethrough in accordance with the punch pattern and the plurality of markings/indicia/print elements 305 in accordance with the print pattern. The punch and print patterns form a cohesive pattern along the panel 200 that is aesthetically pleasing and consistent. That is, in this embodiment the markings 305 that are printed onto the panel 200 and the holes 105 formed through the panel 200 have the same shape. Furthermore, in this embodiment the markings 305 and the holes 105 are generally of the same size. This further enhances the cohesion among the print and punch patterns on the same panel 200.

In this embodiment, no part of the print pattern intersects any of the holes 105. Furthermore, the markings 305 of the print pattern and the holes 105 are spaced apart by at least 0.25 inches. That is, the closest that any part of the markings 305 of the print pattern are to any part of the holes 105 of the punch pattern is 0.25 inches. In other embodiments, the markings 305 will be spaced at least 0.5 inches from the holes 105. This serves a distinct purpose, which is in case of a situation where the print pattern is misaligned or misprinted, it will not be very noticeable. By maintaining at least a 0.25 inch gap between the markings 305 and the holes 105, a slight misalignment during printing will still not result in the markings 305 contacting or intersecting the holes 105. Thus, the same cohesive and consistent overall design pattern will remain even with a small misalignment or misprint, and this will not be noticeable by a person viewing the panels 200 from within the interior space in which the panels 200 are installed.

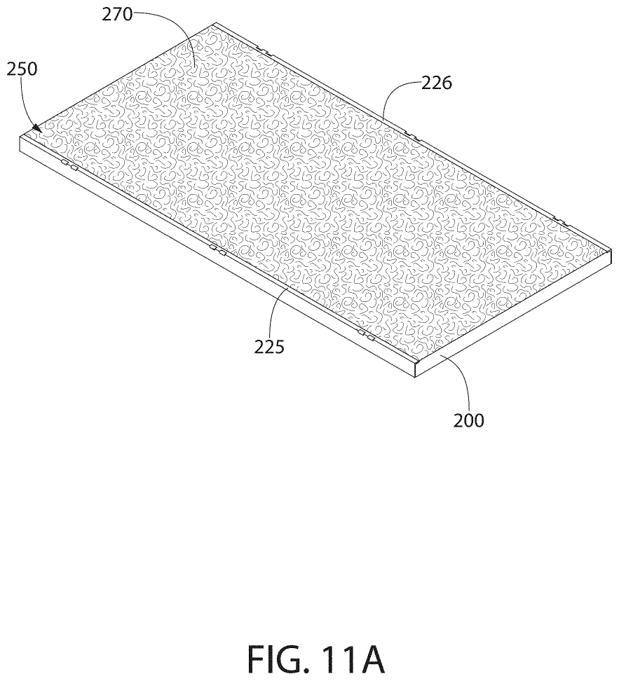

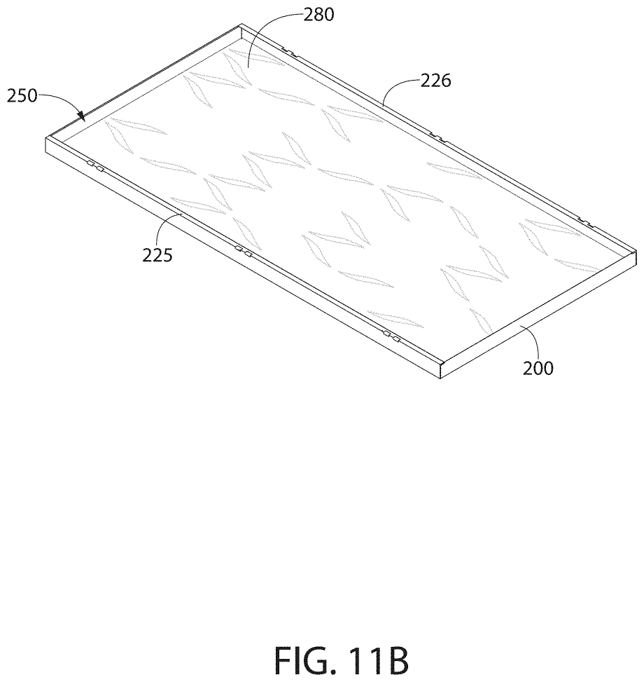

Referring to FIGS. 1, 11A, and 11B, step 80, which is an optional step in some embodiments, comprises installing an acoustic backer 270 (FIG. 11A) or a translucent backer 280 (FIG. 11B) into the rear cavity 250 of the panel 200. The acoustic backer 270 may be formed from a sound absorbing material, such as an acoustic polyethylene terephthalate (PET), such as an acoustic PET felt material, or the like in various different embodiments. In FIG. 11B, the translucent backer 280 is used instead of the acoustic baker 270. The translucent backer 280 may be formed from polycarbonate, and more specifically, light transmitting frosted polycarbonate. Thus, when the translucent backer 280 is used, light from a light source positioned behind the panel 200 may transmit through the translucent backer 280 and through the holes 105 in the panel 200 where the light can be emitted into the room at which the panels 200 are installed. The backers 270, 280 may be omitted in alternative embodiments.

Referring to FIG. 12, several of the panels 200 are illustrated in different stages of the installation process. In FIG. 12, the panels 200 are being mounted to an overhead grid assembly 350. As noted above, the panels 200 may also be mounted to a wall. The overhead grid assembly 350 may comprise a plurality of beam members 351 positioned in an intersecting manner to form square or rectangular openings within which the panels 200 are to be located in their final installed position.

In this embodiment, a torsion spring 360 is inserted into each pair of slots 230, 240. To mount the panels 200 to the overhead grid assembly 350, the torsion springs 360 are squeezed and then inserted into slots in the beam members 351. The user then pushes the panel upward towards the overhead grid assembly 350 until the panel sits flush against the beam members. Detaching the panels 200 from the overhead grid assembly 350 requires performing these steps in reverse, by pulling the panel 200 away from the beam members 351 and then squeezing the torsion springs 360 to pull the torsion springs back out of the slots in the beam members 351. Of course, the manner in which the panels 200 are configured to be mounted to a ceiling or wall is not to be limiting of the present invention in all embodiments. Thus, other techniques now known or later developed for mounting panels 200 of this type to a ceiling or to a wall may be used with the panels 200 described herein. For example, the panels 200 may be configured to rest atop of a T-shaped bar of an overhead grid assembly. In other embodiments, the panels 200 may be configured for mounting to other styles of rails or guide bars. In still other embodiments, the panels 200 may be configured for direct attachment to an existing wall or ceiling (i.e., drywall). The manner of installation is not intended to be limiting of the present invention unless specifically claimed as such.

When the panels 200 are installed, light fixtures may be positioned behind the panels 200. As such, light emitted from the light fixtures will pass through the holes in the panels to illuminate the interior space within which the panels 200 are installed. Thus, the holes are locations through which light may pass into the interior space, providing the holes with a function beyond pure aesthetics. In some embodiments, the supported panels 200 may include acoustic properties with a NRC value of 0.35-0.95 when tested to the ASTM C423, with a Type E400 ASTM E795 mounting type. In some embodiments, these acoustic properties may exist when the acoustic backer 270 is coupled to the panel 200 as described herein.

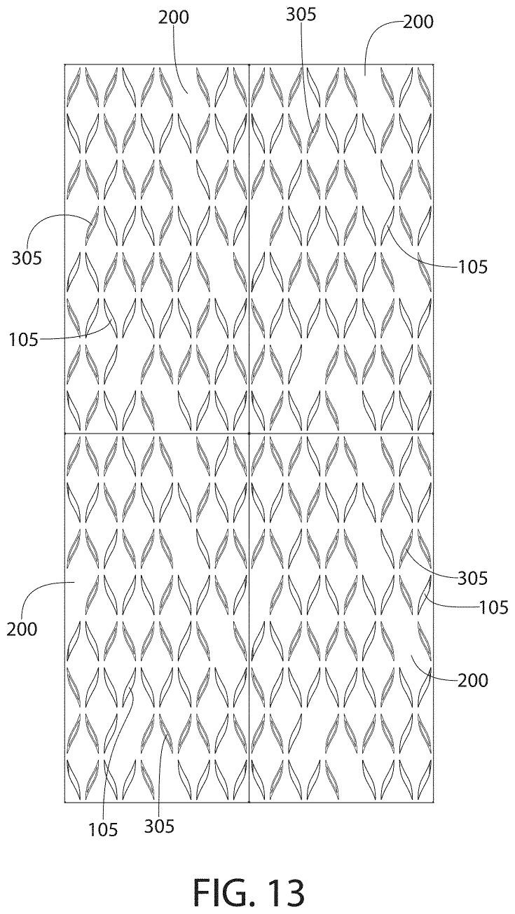

FIG. 13 illustrates a front view of four of the panels 200 positioned in a side-by-side arrangement. The panels 200 each have a plurality of the holes 105 formed therein and the markings or indicia or print elements 305 that are printed thereon. The exact pattern of the print and punch patterns may be different than that which is shown in other embodiments. However, the cohesiveness between the punch pattern and the print pattern may be desirable in some embodiments. The four panels 200 may have the same print and punch patterns, or different print and punch patterns in various different embodiments.

FIG. 14 illustrates a panel 400 in accordance with another embodiment of the present invention. The panel 400 is manufactured in the same manner as described herein and in accordance with the same steps described herein. Thus, the panel 400 comprises a plurality of holes 401 in accordance with a punch pattern and a plurality of print elements 402 in accordance with a print pattern. The shape, style, and location of the holes 401 and the print elements 402 differs from the previous embodiment. However, it should be noted that the holes 401 and the print elements 402 have a consistent shape. That is, in this embodiment the holes 401 comprise two or three or more linear segments that form a continuous hole 401. Similarly, the print elements 402 comprise two or three or more linear segments that form a continuous print element 402. The linear segments of the holes 401 and of the print elements 402 are of the same shape, thereby creating a cohesive overall design pattern.

There is a nuance in the punch process when forming the panel 400 of FIG. 14, as compared to the formation of the panel 200 described above. Specifically, the various linear segments of each of the holes 401 may be formed by the same punch tool, and the rotation of the punch tool and movement of the panel (or flat metal sheet thereof prior to bending) 400 along the punching machine will cause successive punches with the same tool to form a single continuous hole. Specifically, the punching tool may shift and/or rotate and the panel 400 (or flat metal sheet) may also shift and/or rotate so that successive punches (i.e., two or more punches in a row) with the punching tool will create a single continuous hole (the holes 401) with a complex shape that differs from the shape of the punching tool. Stated another way, successive punches with the same punching tool will enlarge the hole so that a single continuous hole 401 is formed by two or more successive punches with the punching tool of the punching machine. That is, successive punches will punch the panel 400 along intersecting regions, so that although multiple punches/strikes are being used, the hole 401 being formed is a single continuous hole with a complex shape that differs from the shape of the punching tool.

In this embodiment, like the one previously described, the holes 401 and the print elements 402 do not intersect. Furthermore, the holes 401 and the print elements 402 may be spaced apart by a distance of at least 0.25 inches to avoid making misprints noticeable to a viewer.

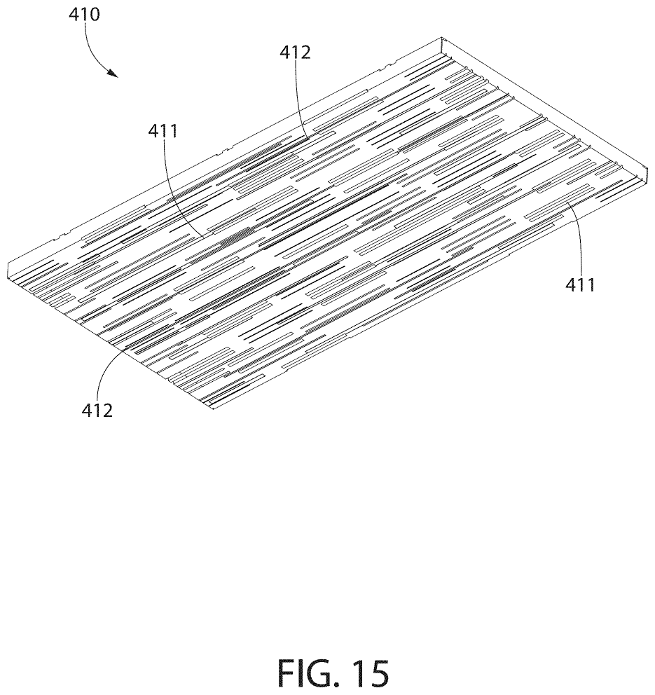

Referring to FIG. 15, yet another embodiment of a panel 410 having holes 411 punched therein in accordance with a punch pattern and print elements 412 printed thereon in accordance with a print pattern is illustrated. Once again, the holes 411 and the print elements 412 have a similar shape. In this embodiment, the holes 411 and the print elements 412 are in the shape of an elongated rectangle. While the holes 411 and the print elements 412 have a variation in length and width relative to one another and even amongst themselves (i.e., some of the holes 411 have different length/width than others, and some of the print elements 412 have different length/width than others), they all have the generally same rectangular shape, thereby creating cohesiveness in the overall design pattern on the panel 410.

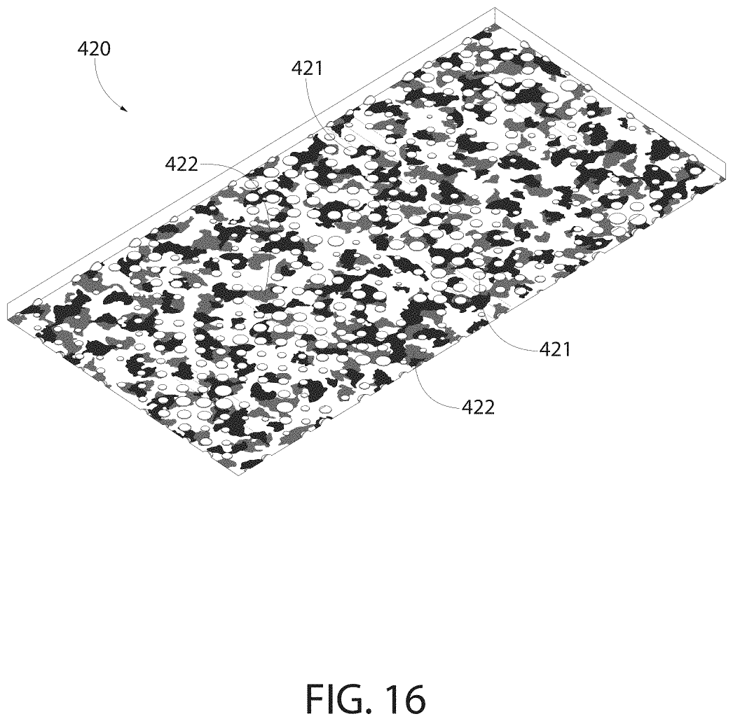

FIG. 16 illustrates still another embodiment of a panel 420 having holes 421 punched therethrough in accordance with a punch pattern and print elements 422 printed thereon in accordance with a print pattern. In this embodiment, the holes 421 are circular but have varying diameter. Furthermore, the print elements 422 form a camouflage design. The print elements 422 overlap with some of the holes 421, but not all of the holes 421. That is, some of the holes 421 are spaced entirely apart from the print elements 422, while others overlap with the print elements 422 either partially or entirely. Furthermore, it should be noted that in this embodiment some of the holes 421 extend continuously along the display portion and sidewall portion of the panel 420. Thus, when two of the panels 420 are positioned in a side-by-side arrangement, the holes 421 that extend to the edges of the display portion and up the sidewall portions from two adjacent panels 420 will form a single continuous opening when viewed by a person.

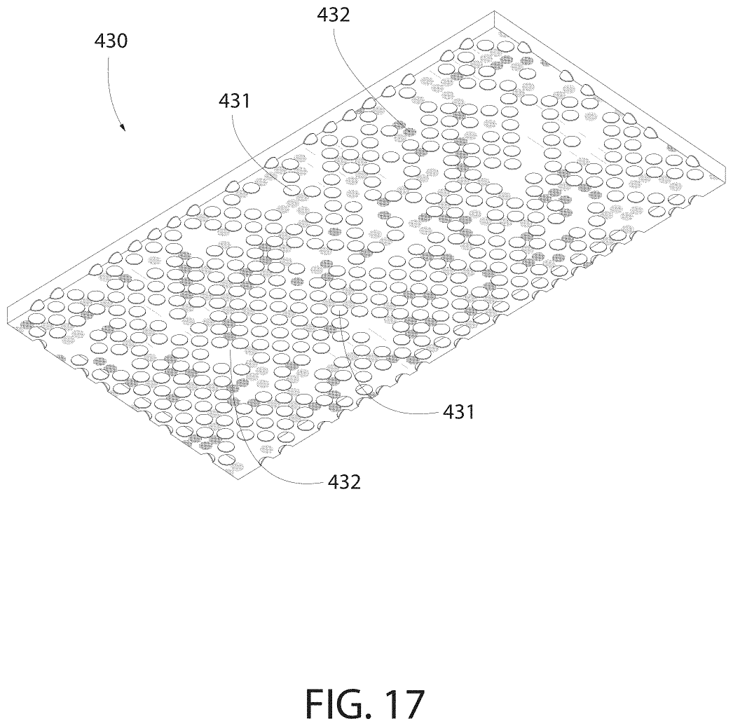

FIG. 17 illustrates still another embodiment of a panel 430 having holes 431 punched therethrough in accordance with a punch pattern and print elements 432 printed thereon in accordance with a print pattern. In this embodiment, the holes 431 are all circular with the same diameter, and the print elements 432 are circular, but formed by a dot-matrix arrangement. The print elements 432 are illustrated in two shades of grayscale to indicate that the print elements 432 may be formed from two different colors. However, the print elements 432 may all be the same color or may be formed from more than two different colors in other embodiments. The holes 431 and the print elements 432 are all circular, thus giving them a similar shape and providing for a cohesive overall design pattern on the panel 430.

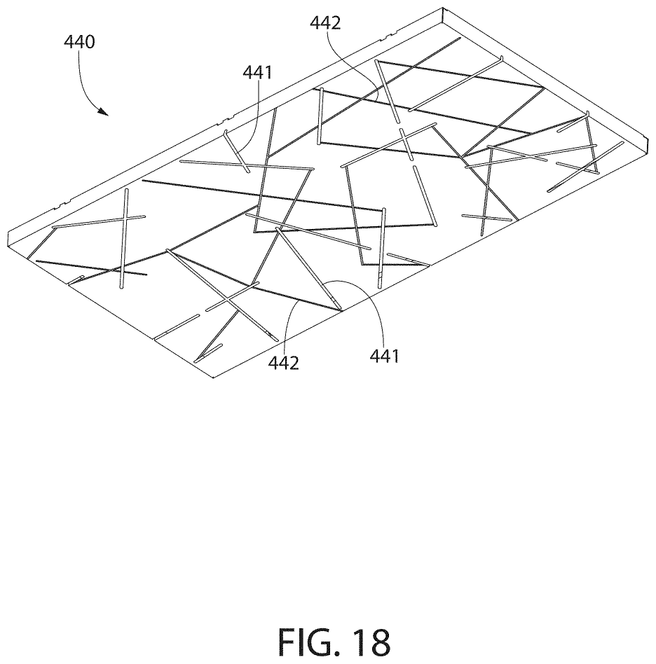

Finally, FIG. 18 illustrates still another embodiment of a panel 440 having holes 441 punched therethrough in accordance with a punch pattern and print elements 442 printed thereon in accordance with a print pattern. In this embodiment, the holes 441 and the print elements 442 are all linear segments of varying length. Furthermore, in this embodiment some of the holes 441 and some of the print elements 442 intersect each other. Moreover, some of the holes 441 intersect others of the holes 441 and some of the print elements 442 intersect others of the print elements 442. This results in an overall design whereby it is not readily discernible to a viewer whether the design elements are formed by the holes 441 or the print elements 442. When such a panel 440 is installed with a light fixture behind the panel 440, this can create a favorable aesthetic whereby the light passes through the holes 441, but not the print elements 442, creating a beautiful and desirable overall aesthetic within an interior space.

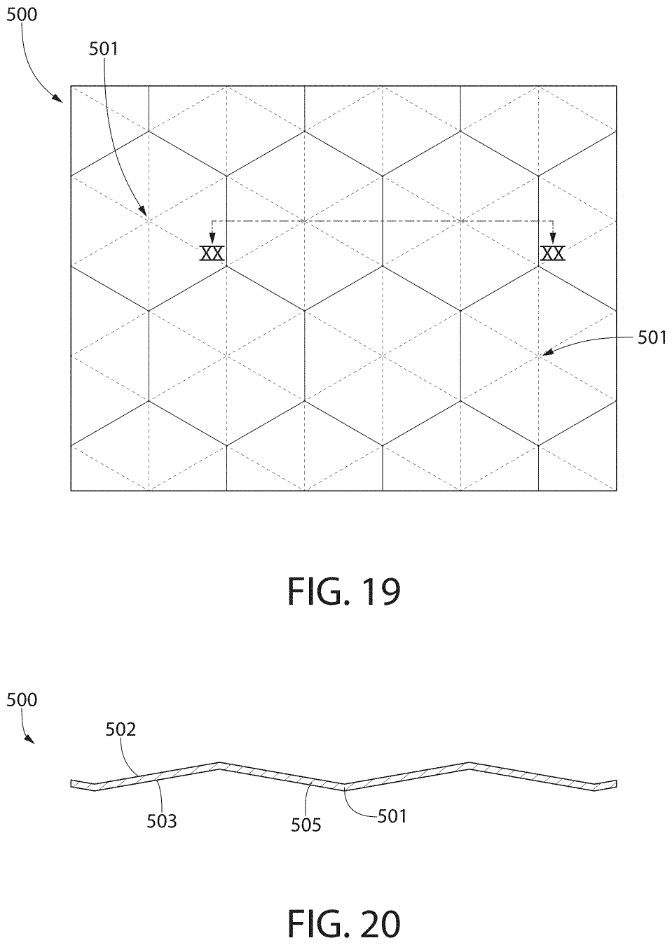

Referring to FIGS. 19 and 20, another embodiment of the present invention will be described. FIGS. 19 and 20 illustrate a panel 500 having a plurality of three-dimensional shapes 501 formed therein. The three-dimensional shapes 501 may be formed into the panel 500 during a punching process with a punching machine that is configured to punch the panel 500 into different shapes without punching holes through the panel 500. As described above with reference to the prior embodiments, the three-dimensional shapes 501 may be formed into the flat metal sheet prior to it being bent into the panel 500. Furthermore, after forming the three-dimensional shapes 501 into the panel 500 (or flat metal sheet), in some embodiments holes may also be formed through the panel 500 using the techniques described herein above. In such embodiments, the panels 500 will have three-dimensional surface ornamentation and holes for design effect and for passage of light therethrough as discussed herein above.

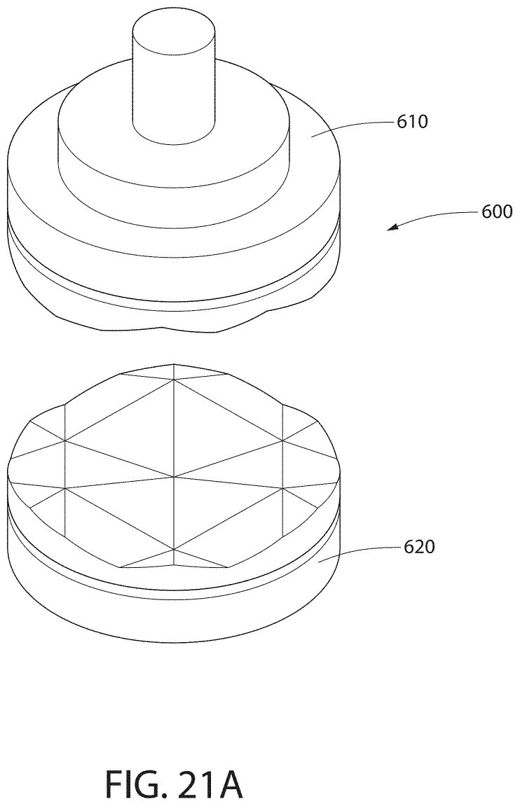

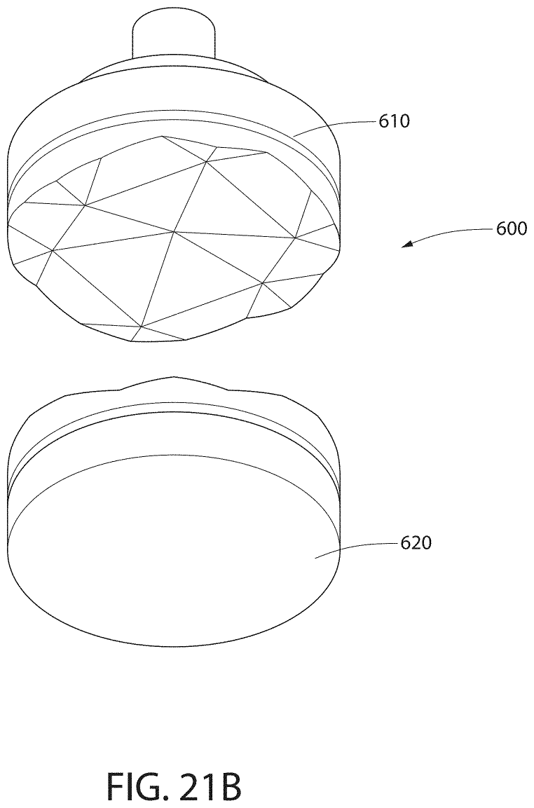

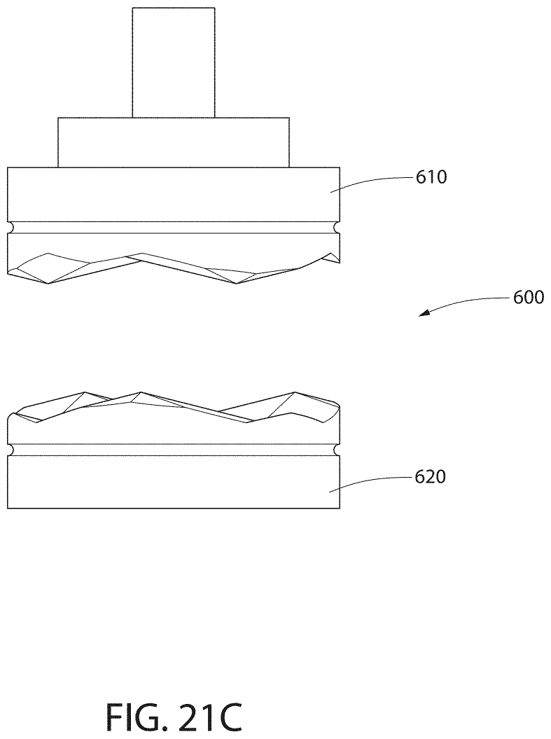

When the punching machine is used to create three-dimensional shapes 501 in the panel 500 (or flat metal sheet prior to formation of the panel 500 by bending the edges of the flat metal sheet as described herein above), the punching machine causes the panel 500 to deform as best shown in FIG. 20. In particular, the punching tool strikes a rear surface 502 of the panel 500 and causes it to deform inwardly, which causes the panel 500 to form protruding features 505 which protrude from a front surface 503 of the panel 500. The difficulty is in creating a punching disk/die (male and female parts) that can create these three-dimensional surface features. Specifically, typical punching tools require a border around the actual punching die that is flat. The three-dimensional shapes or surface features 501 of the panel 500 have very small, or in some cases no flat areas on them. Therefore, punching tools must be created that do not contain any flat areas and that overlap the areas that have already been formed into a three-dimensional shape during a successive strike. FIGS. 21A-21C illustrate such a punching tool 600, and will be described in greater detail below. That is, the border region of the punching die must match the shape of the panel with the previously created three-dimensional features therein. If the border region of the punching die were flat, successive punches would alter the previously made three-dimensional surface features/protrusions. Such punching tools that do not have flat areas but instead have border regions that match the shape of the previously formed three-dimensional shapes will be able to generate three-dimensional punched out shapes, such as those illustrated in FIGS. 19 and 20 or any other three-dimensional shape.

Referring to FIGS. 21A-21C, a punching tool 600 comprising a first punching die 610 and a second punching die 620 is illustrated in accordance with an embodiment of the present invention. The punching tool 600 is designed and configured to punch three-dimensional shapes into a panel, such as the panel 500 described above with reference to FIGS. 19 and 20. The first and second punching dies 610, 620 are shaped so that when they meet during a punching operation, they create a three-dimensional pattern/design into the panel. That is, the first punching die 610 is located adjacent to a first surface of the panel and the second punching die 620 is located adjacent to a second surface of the panel. The first and/or second punching dies 610, 620 are moved quickly to strike the panel such that the panel becomes sandwiched between the first and second punching dies 610, 620, which create a three-dimensional deformation pattern into the panel. The exact shape of the three-dimensional deformation pattern may be adjusted by adjusting the contours of the surfaces of the first and second punching dies 610, 620 which come into contact with the panel during the punching process.

As mentioned above, the punching dies 610, 620 do not have any flat border areas. That is, the punching dies 610, 620 are contoured with three-dimensional features all the way to the border or peripheral edge thereof. As a result, the three-dimensional shapes that are punched into the panel using the punching dies 610, 620 also lack any flat areas. That is, the panel can be formed with a plurality of the three-dimensional shape profiles thereon with no flat areas between the different three-dimensional shapes, as shown in FIGS. 19 and 20, for example.

While the invention has been described with respect to specific examples including presently preferred modes of carrying out the invention, those skilled in the art will appreciate that there are numerous variations and permutations of the above described systems and techniques. It is to be understood that other embodiments may be utilized and structural and functional modifications may be made without departing from the scope of the present invention. Thus, the spirit and scope of the invention should be construed broadly as set forth in the appended claims.

1. A method for manufacturing an architectural panel, the method comprising:
punching a plurality of holes into a flat metal sheet using one or more punching tools of a punching machine to create a punch pattern in the flat metal sheet;
bending the flat metal sheet to form a panel comprising a display portion having an inner surface and an outer surface and one or more sidewall portions extending from the inner surface of the display portion;
printing a print pattern onto the outer surface of the display portion of the panel; and
coating the flat metal sheet with a powder coating or a liquid-applied paint finish prior to printing the print pattern onto the outer surface of the display portion of the panel.

2. The method according to claim 1 further comprising receiving, at one or more computers, a first input indicative of the punch pattern and a second input indicative of the print pattern, wherein the first input is executed by the punching machine to punch the plurality of holes into the flat metal sheet in accordance with the punch pattern and wherein the second input is executed by a printer to print ink onto the outer surface of the display portion of the panel in accordance with the print pattern.

3. (canceled)

4. (canceled)

5. The method according to claim 1 further comprising applying an adhesion promoter onto at least a portion of the panel to at least partially cover the powder coating or the liquid-applied paint finish prior to printing the print pattern onto the outer surface of the display portion of the panel.

6. The method according to claim 5 wherein steps of the method are performed in the following order:
(1) punching the plurality of holes into the flat metal sheet;
(2) bending the flat metal sheet to form the panel;
(3) coating at least a portion of the panel with the powder coating or the liquid-applied paint finish;
(4) coating at least a portion of the panel with an adhesion promotor to form a layer of the adhesion promoter that covers the powder coating or the liquid-applied paint finish; and
(5) printing the print pattern direction onto the layer of the adhesion promoter.

7. The method according to claim 1 further comprising at least one of:
during the punching the plurality of holes into the flat metal sheet, at least one of shifting and rotating at least one of the one or more punching tools so that a first punch with the at least one of the one or more punching tools creates a hole in the flat metal sheet and at least one successive punch with the at least one of the one or more punching tools enlarges the hole in the flat metal sheet to form a single continuous hole with two successive punches; and
during the punching the plurality of holes into the flat metal sheet, at least one of shifting and rotating at least one of the one or more punching tools between successive punches with the at least one of the one or more punching tools to create a single continuous hole in the flat metal sheet having a complex shape that is different than a shape of the at least one of the one or more punching tools.

8. (canceled)

9. The method according to claim 1 further comprising, prior to printing the print pattern onto the outer surface of the display portion of the panel, positioning the panel on a vacuum fixture of a printer bed of a printer, the vacuum fixture comprising a plurality of suction elements that are detachably coupled to a grid such that the plurality of suction elements are configured to be positioned at any of a plurality of different locations along the grid.

10. The method according to claim 1 further comprising, prior to printing the print pattern onto the outer surface of the display portion of the panel, positioning the panel on a vacuum fixture of a printer bed of a printer, the vacuum fixture comprising structural features that cover one or more of the holes in the panel, and applying suction to the panel with the vacuum fixture to hold the panel in position during the printing of the print pattern onto the outer surface of the display portion of the panel.

11. (canceled)

12. The method according to claim 1 wherein the panel is bent during the bending of the flat metal sheet to form the panel comprising a generally rectangular box shape such that the one or more sidewalls comprises four sidewalls extending from the inner surface of the display portion of the panel, wherein the panel is further bent during the bending of the flat metal sheet to form the panel so that flanges extend inwardly from distal ends of two opposing ones of the four sidewalls.

13. (canceled)

14. (canceled)

15. The method according to claim 1 further comprising, after bending the flat metal sheet to form the panel, positioning at least one of an acoustic backer or a translucent backer within a cavity defined by the inner surface of the display portion of the panel and inner surfaces of the one or more sidewall portions of the panel.

16. The method according to claim 1 wherein upon bending the flat metal sheet to form the panel, at least one of the holes extends continuously along the display portion and one of the one or more sidewall portions of the panel so that the at least one of the holes extends along an edge formed at an intersection of the display portion and the one of the one or more sidewall portions.

17. The method according to claim 1 wherein the punch pattern and the print pattern form a cohesive combined design pattern on the panel.

18. The method according to claim 1 wherein the punch pattern comprises a plurality of holes having a first shape and the print pattern comprises a plurality of print elements having a second shape, the first and second shapes being substantially the same.

19. The method according to claim 1 wherein the print pattern comprises a plurality of print elements and the punch pattern comprise a plurality of holes, wherein edges and ends of the plurality of print elements do not terminate at any of the plurality of holes, and wherein edges and ends of the plurality of holes does not terminate at any of the plurality of print elements.

20. The method according to claim 19 wherein the edges and the ends of the plurality of print elements are spaced at least 0.25 inches from each of the plurality of holes, and wherein the edges and the ends of the plurality of holes are spaced at least 0.25 inches from each of the plurality of print elements.

21. The method according to claim 18 wherein at least one of the print elements and at least one of the plurality of holes intersect.

22. The method according to claim 18 wherein none of the print elements intersect any of the holes.

23. (canceled)

24. The method according to claim 1 further comprising applying a clear coat finish onto at least the display surface of the panel as a protective coating.

25. A method for manufacturing an architectural panel, the method comprising the following steps being performed sequentially:
punching a plurality of holes into a flat metal sheet using one or more punching tools of a punching machine to create a punch pattern in the flat metal sheet;
bending the flat metal sheet to form a panel comprising a display portion having an inner surface and an outer surface and one or more sidewall portions extending from the inner surface of the display portion;
coating the panel with a powder coating so that the powder coating covers at least the outer surface of the display portion of the panel and edges of the panel which surround the holes;
applying an adhesion promoter onto the powder coating at least along the display portion of the panel to form a layer of the adhesion promoter that covers the powder coating; and
printing an ink onto the layer of the adhesion promoter in a print pattern.

26.-28. (canceled)

29. The method according to claim 25 wherein the punch pattern comprises the plurality of holes or hole segments each having a first shape and the print pattern comprises a plurality of print features or print segments each having a second shape, the first and second shapes being the same.

30.-40. (canceled)

41. A method for manufacturing an architectural panel, the method comprising:
punching a plurality of holes into a flat metal sheet to create a punch pattern in the flat metal sheet;
bending the flat metal sheet to form a panel comprising a display portion and one or more sidewall portions;
coating at least a portion of the panel with a powder coating; and
printing a print pattern along the display portion of the panel.

42. The method according to claim 41 further comprising applying an adhesion promoter onto at least a portion of the powder coating prior to printing the print pattern so that the print pattern is printed onto the adhesion promoter, and wherein the method is performed in order of punching, bending, coating with the powder coating, applying the adhesion promoter, and then printing.

43. (canceled)

44. The method according to claim 41 further comprising:
prior to bending the flat metal sheet to form the panel, punching a plurality of three-dimensional shapes into the flat metal sheet;
wherein protruding features of the three-dimensional shapes protrude from an outer surface of the display portion such that there is no flat border surrounding the three-dimensional shapes; and
wherein the three-dimensional shapes are formed individually on a punching machine.

45. (canceled)
